(19) United States
(12) Patent Application Publication
(10) Pub. No.: US 2024/0394729 A1
(43) Pub. Date: Nov. 28, 2024

(54) PRODUCT CONSUMPTION DATA CLUSTERING

(71) Applicant: HONEYWELL INTERNATIONAL INC., Charlotte, NC (US)

(72) Inventors: Aishwarya Coffey, Dublin (IE); Himadri Pal, Sugar Land, TX (US); Lakshmi Priya Gayatri Vutukuri, Atlanta, GA (US)

(21) Appl. No.: 18/202,318

(22) Filed: May 26, 2023

(51) Int. Cl. G06Q 30/0201; G06F 16/906

(52) U.S. Cl. CPC G06Q 30/0201; G06F 16/906

(57) ABSTRACT

Approaches for product consumption data clustering are described. In an example implementation, cumulative product consumption data of each product of plurality of products, including at least three data points indicative of varying cumulative product consumption quantities with respect to varying unit product values, is obtained and re-scaled by normalizing varying cumulative product consumption quantities and varying unit product values to be within first predefined numerical range and second predefined numerical range, respectively. Re-scaled cumulative product consumption data of each product is clustered, by cluster generation module, into plurality of clusters based on mapping of re-scaled cumulative product consumption data with respect to plurality of non-overlapping regions in a predefined cluster determination plot generated by processor. Each non-overlapping region is confined by subset of values within first predefined numerical range associated with cumulative product consumption quantity and subset of values within second predefined numerical range associated with unit product value.

### BACKGROUND

Any consumable product, such as a cryocooler, a transponder, a transducer, etc., generally has a product value associated with it. The product value is to be expended by a customer in order to acquire the product.

### BRIEF DESCRIPTION OF FIGURES

The following detailed description references the drawings, wherein:

FIG. 1 illustrates a block diagram of a system for product consumption data clustering, according to an example of the present subject matter;

FIG. 2A and FIG. 2B illustrate a block diagram of a system for product consumption data clustering, according to an example of the present subject matter;

FIG. 3 illustrates a graph of demand curve data for a product, according to an example of the present subject matter;

FIG. 4 illustrates a graph of cumulative product consumption data for a product, according to an example of the present subject matter;

FIG. 5 illustrates a graph of re-scaled cumulative product consumption data for a product, according to an example of the present subject matter;

FIG. 6A illustrates a predefined cluster determination plot, according to an example of the present subject matter;

FIG. 6B illustrates a predefined cluster determination plot, according to an example of the present subject matter;

FIG. 7 illustrates a plurality of clusters, according to an example of the present subject matter;

FIG. 8 illustrates a method for product consumption data clustering, according to an example of the present subject matter;

FIG. 9A and FIG. 9B illustrate a method for product consumption data clustering, according to an example of the present subject matter; and

FIG. 10 illustrates a system environment implementing a non-transitory computer readable medium for product consumption data clustering, according to an example of the present subject matter.

### DETAILED DESCRIPTION

When a customer approaches an owner of a product to acquire the product, the owner has to quote an optimal product value for the product that is to be expended by the customer to acquire the product. The owner may include a manufacturer or a seller of the product. The optimal product value for the product may be a value at which a margin for the product is maximum. In an example, the margin (M_{PV}) at a product value may be calculated based on equation (1) given below. As evident from the equation (1), the margin (M_{PV}) for the product depends on the product value (PV) of the product, the cost incurred (CI) on the product, and the quantity (Q_{PV}) of the product sold at the product value.

M_{PV}=(PV−CI)*Q_{PV} equation (1)

The optimal product value for a product is calculated manually by the owner based on a comparison of margins for the product at a plurality of historical product values. One of the plurality of historical product values at which the margin is the highest can be selected as an optimal product value for the product.

The optimal product value, when calculated manually, consumes a lot of time. Further, since the plurality of historical product values may not include an actual optimal product value at which the margin for the product could be maximum, the selected optimal product value may be inaccurate. While calculating the optimal product value manually, there is a high possibility of committing errors. Further, the amount of data related to the plurality of historical product values that can be assessed within a particular time interval is limited. Therefore, the probability that the selected optimal product value actually maximizes the margin for the product is low.

The present subject matter describes approaches for clustering product consumption data for a plurality of products into a plurality of clusters or incorporating product consumption data of a product in a cluster from the plurality of clusters. The plurality of clusters may be used to efficiently and accurately determine an optimal unit product value for a product that maximizes the margin for the product.

According to an example implementation of the present subject matter, cumulative product consumption data is obtained for a product. The cumulative product consumption data includes at least three data points, where the at least three data points are indicative of varying cumulative product consumption quantities with respect to varying unit product values for the product. The cumulative product consumption data is re-scaled by normalizing the varying cumulative product consumption quantities to be within a first predefined numerical range and normalizing the varying unit product values to be within a second predefined numerical range. A predefined cluster determination plot is obtained. The predefined cluster determination plot may be generated by the processor and, for example, stored in a memory of the system. The predefined cluster determination plot includes a plurality of non-overlapping regions, where each of the plurality of non-overlapping regions is confined by a subset of values within the first predefined numerical range associated with a cumulative product consumption quantity as ordinates and a subset of values within the second predefined numerical range associated with a unit product value as abscissas. The re-scaled cumulative product consumption data is mapped with respect to the plurality of non-overlapping regions in the predefined cluster determination plot. The re-scaled cumulative product consumption data is then incorporated in a cluster from a plurality of clusters based on the mapping of the re-scaled cumulative product consumption data with respect to the plurality of non-overlapping regions in the predefined cluster determination plot. The cluster is rendered to determine an optimal unit product value for the product. Although the example implementation has been explained with respect to one product, the same example implementation may also be performed for a plurality of products. The re-scaled cumulative product consumption data of each product of the plurality of products may be clustered into a plurality of clusters based on the mapping of the re-scaled cumulative product consumption data with respect to the plurality of non-overlapping regions.

The plurality of clusters described in the present disclosure provides an indication of how a unit product value for a product has historically affected a demand of the product. Therefore, the plurality of clusters is rendered to determine an optimal unit product value for the product.

In an example, the optimal unit product value for the product may be predicted by a value prediction module of a system. To predict an optimal unit product value for a product, the value prediction module may first determine a relationship between the demand of the product with respect to the unit product values based on an analysis of a cluster, from the plurality of clusters, in which the re-scaled cumulative product consumption data of that product is incorporated. Based on the relationship between the demand of the product with respect to the unit product values, the value prediction module may predict the optimal unit product value that maximizes the margin or the demand for the product.

In another example, the optimal unit product value for the product may be obtained, by a value prediction module of a system, based on an input from a user. For example, to determine an optimal unit product value for the product, the plurality of clusters may be presented to the user on a display of a device, such as a mobile device, a computer, a laptop, etc. Then, an input may be received from the user with respect to an optimal unit product value for a product based on a cluster, from the plurality of clusters, in which the re-scaled cumulative product consumption data of that product is incorporated. For example, if the user observes, through the cluster, that there is a drastic drop in the demand as the unit product value increases, an input may be received, from the user, to maintain the unit product value of the product at the current value.

The optimal unit product value, decided by the user or predicted by the system, for the product may be obtained and provided, by the value prediction module, as feedback to the cluster generation module. The cluster generation module may update the plurality of clusters based on the optimal unit product value to continuously improve the system for predicting the optimal unit product value.

The cluster generation module may train a machine learning (ML) model for predicting the optimal unit product value, determining the impact of the optimal unit product value on the demand for production of the product, or fine-tuning attributes that impact the production and supply-chain of the product. In an example, inputs to the ML model may be the name, the country, the customer, the product consumption quantity, and the cluster associated with the product. The ML model may be continuously improved based on the optimal unit product value and other inputs to the ML model.

The cumulative product consumption data is re-scaled so that the varying cumulative product consumption quantities of each product lie in a same predefined numerical range and the varying unit product values of each product lie in a same predefined numerical range. After re-scaling, the cumulative product consumption data can be easily clustered into the plurality of clusters.

Further, the plurality of clusters includes the re-scaled cumulative product consumption data having at least three data points. This means that the cumulative product consumption data of each product includes varying cumulative product consumption quantities at a minimum of three varying unit product values. As a result, the plurality of clusters forms a reliable set of data to efficiently and accurately determine an optimal unit product value for a product that maximizes the margin for the product.

The present subject matter is further described with reference to the accompanying figures. Wherever possible, the same reference numerals are used in the figures and the following description to refer to the same or similar parts. It should be noted that the description and figures merely illustrate principles of the present subject matter. It is thus understood that various arrangements may be devised that, although not explicitly described or shown herein, encompass the principles of the present subject matter. Moreover, all statements herein reciting principles, aspects, and examples of the present subject matter, as well as specific examples thereof, are intended to encompass equivalents thereof.

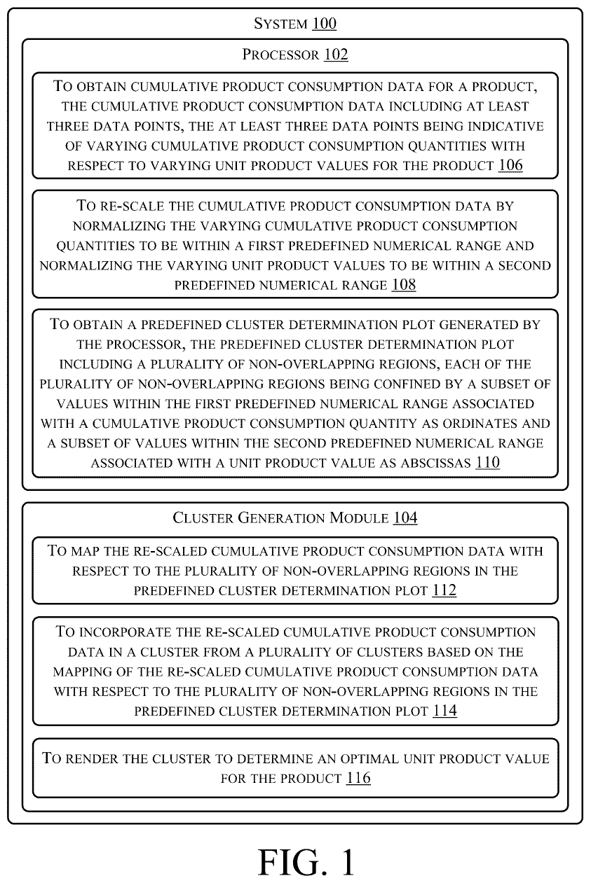

FIG. 1 illustrates a block diagram of a system 100 for product consumption data clustering, as per one example. The system 100 includes a processor 102 and a cluster generation module 104. The system 100 may be implemented in any computing system, such as a storage array, a server, a desktop or a laptop computing device, a distributed computing system, or the like. Although not depicted, the system 100 may include other components, such as interfaces to communicate over the network or with external storage or computing devices, display, input/output interfaces, operating systems, applications, data, and other software or hardware components (all of which have not been depicted).

The processor 102 may be implemented as a dedicated processor, a shared processor, or a plurality of individual processors, some of which may be shared. As used herein, the term “processor” is not limited merely to those integrated circuits referred to in the art as a processor, but broadly refers to a microcontroller, a microcomputer, a programmable logic controller, an application-specific integrated circuit, and any other programmable circuit.

In an example, the cluster generation module 104 may be implemented via the use of hardware or combinations of hardware and software. In another example, the cluster generation module 104 may be coupled to, and accessible by, the processor 102 for execution of the functions of the cluster generation module 104.

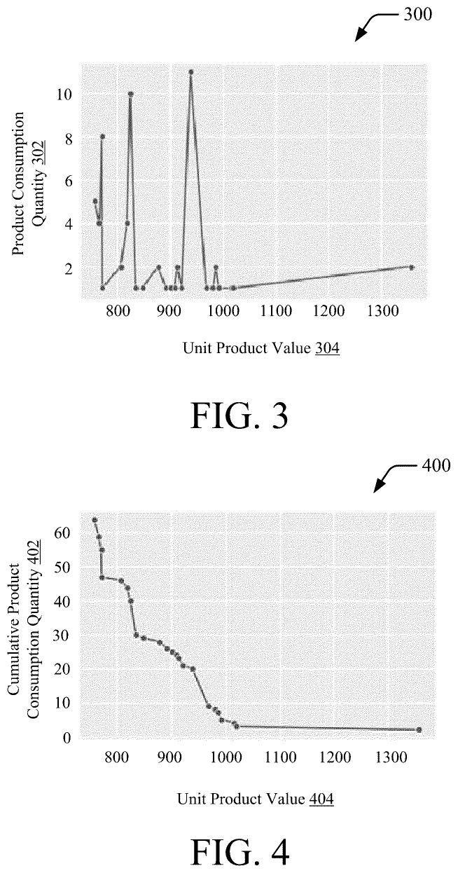

In an example, at block 106, the processor 102 obtains cumulative product consumption data for a product. The cumulative product consumption data, for example, may include data related to the sale of a product, for example, cumulative sales quantities of the product, demand of the product, unit selling amount of the product, discount on the product, etc. The cumulative product consumption data includes at least three data points. The at least three data points being indicative of varying cumulative product consumption quantities with respect to varying unit product values for the product. In other words, the cumulative product consumption data for the product includes varying cumulative product consumption quantities with respect to at least three varying unit product values. A cumulative product consumption quantity of a product may be indicative of a cumulative sales quantity associated with the product. A unit product value of a product may be indicative of a unit selling amount associated with the product. The cumulative product consumption data has been described in detail with an example graph of the cumulative product consumption data illustrated in FIG. 4.

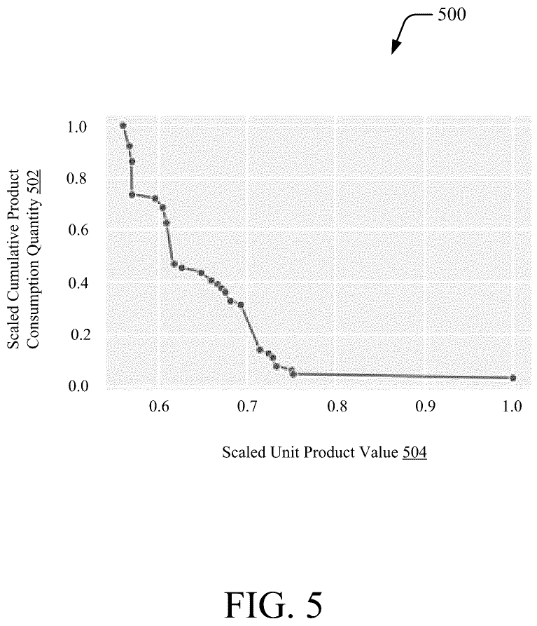

At block 108, the processor 102 re-scales the cumulative product consumption data by normalizing the varying cumulative product consumption quantities to be within a first predefined numerical range and normalizing the varying unit product values to be within a second predefined numerical range. The re-scaled cumulative product consumption data has been described in detail with an example graph of the re-scaled cumulative product consumption data illustrated in FIG. 5.

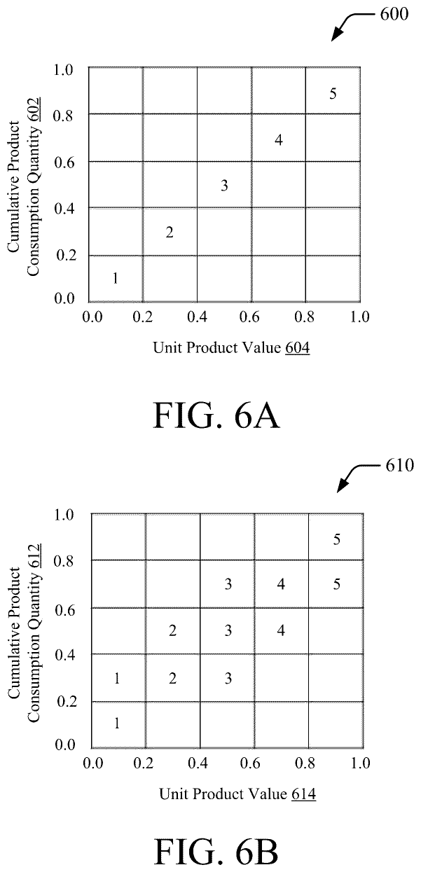

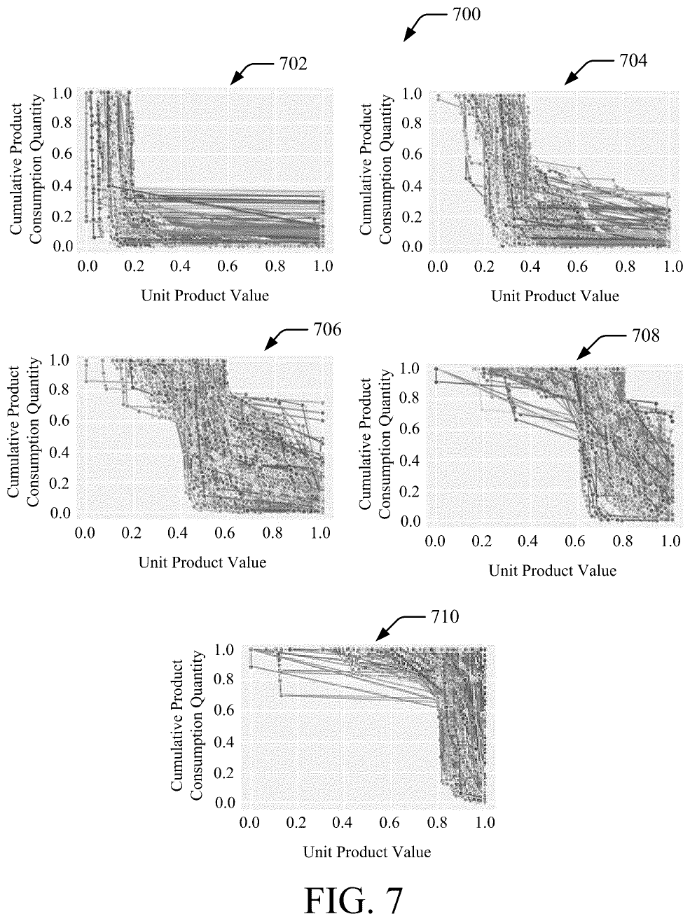

At block 110, the processor 102 obtains a predefined cluster determination plot generated by the processor 102. In an example, the predefined cluster determination plot generated by the processor 102 may be stored in an internal memory (not shown) of the system 100 or in an external memory (not shown). In this example, the predefined cluster determination plot may be obtained from the internal memory of the system 100 or the external memory at block 110. The predefined cluster determination plot includes a plurality of non-overlapping regions. Each of the plurality of non-overlapping regions is confined by a subset of values within the first predefined numerical range associated with a cumulative product consumption quantity as ordinates and a subset of values within the second predefined numerical range associated with a unit product value as abscissas. The predefined cluster determination plot has been described in detail with examples of the predefined cluster determination plot illustrated in FIG. 6A and FIG. 6B.

In an example, at block 112, the cluster generation module 104 maps the re-scaled cumulative product consumption data with respect to the plurality of non-overlapping regions in the predefined cluster determination plot.

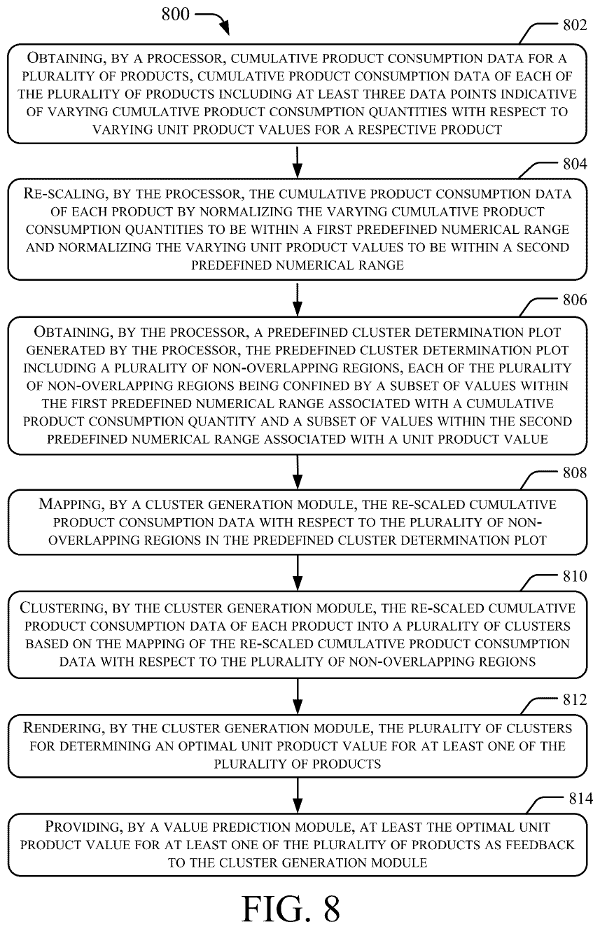

At block 114, the cluster generation module 104 incorporates the re-scaled cumulative product consumption data in a cluster from a plurality of clusters based on the mapping of the re-scaled cumulative product consumption data with respect to the plurality of non-overlapping regions in the predefined cluster determination plot. The plurality of clusters have been described in detail with examples of the plurality of clusters illustrated in FIG. 7.

At block 116, the cluster generation module 104 renders the cluster to determine an optimal unit product value for the product. The optimal unit product value may either be determined by the system 100 or obtained by the system 100 through an input received from a user.

In an example, to determine or predict an optimal unit product value for a product, the system 100 may first determine a relationship between the demand of the product with respect to the varying unit product values based on an analysis of a cluster, from the plurality of clusters, in which the re-scaled cumulative product consumption data of that product is incorporated. Based on the relationship between the demand of the product with respect to the unit product values, the system 100 may predict the optimal unit product value that maximizes the margin or the demand for the product.

In another example, to determine an optimal unit product value for the product, the plurality of clusters may be presented to a user on a display (not shown) of the system 100 or a display of an external device, such as a mobile device, a computer, a laptop, etc. An input may be received from the user with respect to an optimal unit product value for a product based on a cluster, from the plurality of clusters, in which the re-scaled cumulative product consumption data of that product is incorporated. For example, if the user observes, through the cluster, that there is a drastic drop in the demand as the unit product value increases, an input may be received from the user to maintain the unit product value of the product at the current value. In this way, the optimal unit product value for the product may be obtained, by the system 100, through the input received from the user.

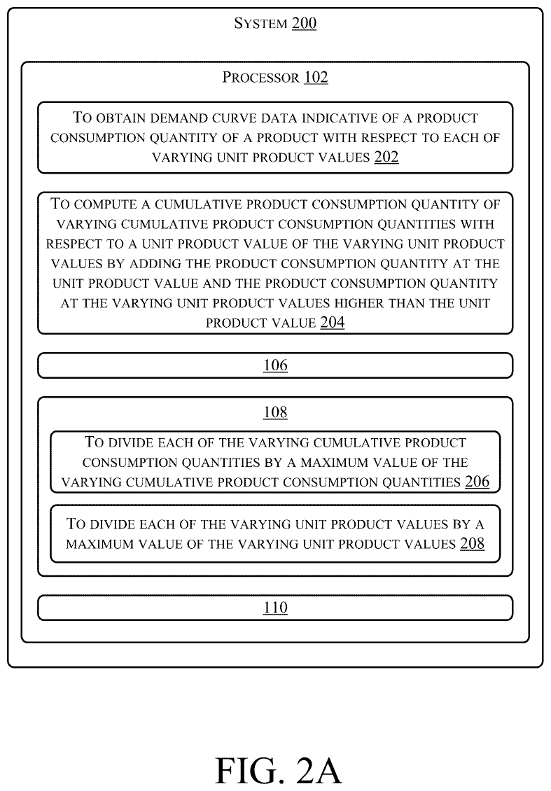

FIG. 2A and FIG. 2B illustrate a block diagram of a system 200 for product consumption data clustering, as per one example. The system 200 may be structurally same or similar to the system 100 as explained. The system 200 includes the processor 102 and the cluster generation module 104.

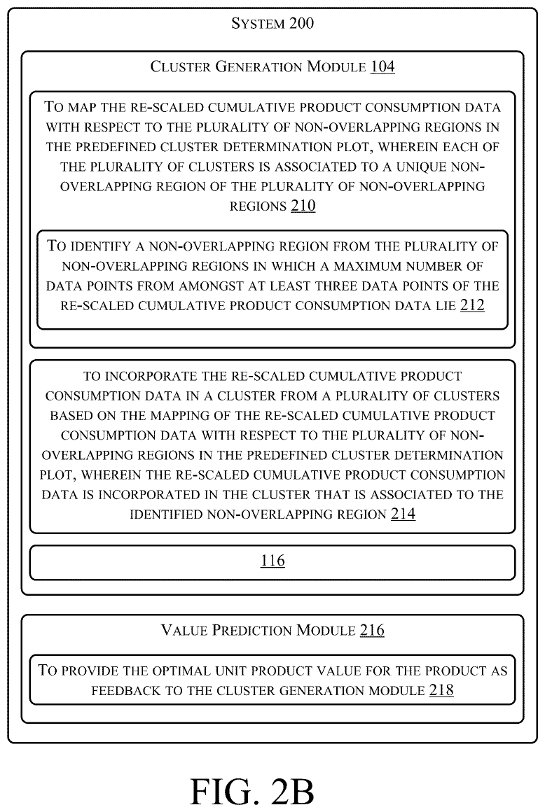

In an example, at block 202, the processor 102 obtains demand curve data indicative of a product consumption quantity of a product with respect to each of varying unit product values. A product consumption quantity of a product may be indicative of a sales quantity associated with the product. A unit product value of a product may be indicative of a unit selling amount associated with the product. The demand curve data is indicative of the relationship between the demand and the unit product value of the product. The demand curve data has been described in detail with an example graph of the demand curve data illustrated in FIG. 3.

At block 204, the processor 102 computes a cumulative product consumption quantity of varying cumulative product consumption quantities with respect to a unit product value of the varying unit product values by adding the product consumption quantity at the unit product value and the product consumption quantity at the varying unit product values higher than the unit product value. For example, to compute a cumulative product consumption quantity at a unit product value which is lowest amongst the varying unit product values, the product consumption quantities with respect to all of the varying unit product values are added together. Further, to compute a cumulative product consumption quantity at a unit product value which is highest amongst the varying unit product values, the product consumption quantity with respect to the highest unit product value is determined as the cumulative product consumption quantity. As a result, the cumulative product consumption quantity decreases with the increase in the unit product value. In an example, based on the computed cumulative product consumption quantity with respect to each of the varying unit product values, cumulative product consumption data may be generated and stored by the processor 102 in an internal memory (not shown) of the system 200 or an external memory (not shown).

Then, at block 106, the processor 102 obtains cumulative product consumption data for the product. In an example, the cumulative product consumption data may be obtained from the internal memory of the system 200 or the external memory. The cumulative product consumption data includes at least three data points. The at least three data points are indicative of the varying cumulative product consumption quantities with respect to the varying unit product values for the product. The cumulative product consumption data, for example, may include data related to the sale of a product, for example, cumulative sales quantities of the product, demand of the product, unit selling amount of the product, discount on the product, etc. A cumulative product consumption quantity of a product may be indicative of a cumulative sales quantity associated with the product. A unit product value of a product may be indicative of a unit selling amount associated with the product.

Then, at block 108, the processor 102 re-scales the cumulative product consumption data by normalizing the varying cumulative product consumption quantities to be within a first predefined numerical range and normalizing the varying unit product values to be within a second predefined numerical range.

To normalize the varying cumulative product consumption quantities to be within the first predefined numerical range, at block 206, the processor 102 divides each of the varying cumulative product consumption quantities by a maximum value of the varying cumulative product consumption quantities. Further, to normalize the varying unit product values to be within the second predefined numerical range, at block 208, the processor 102 divides each of the varying unit product values by a maximum value of the varying unit product values.

At block 110, the processor 102 obtains a predefined cluster determination plot generated by the processor 102. In an example, the predefined cluster determination plot generated by the processor 102 may be stored in the internal memory of the system 200 or in the external memory. In this example, the predefined cluster determination plot may be obtained from the internal memory of the system 200 or the external memory at block 214. The predefined cluster determination plot includes a plurality of non-overlapping regions. Each of the plurality of non-overlapping regions is confined by a subset of values within the first predefined numerical range associated with a cumulative product consumption quantity as ordinates and a subset of values within the second predefined numerical range associated with a unit product value as abscissas.

As illustrated in FIG. 2B, at block 210, the cluster generation module 104 maps the re-scaled cumulative product consumption data with respect to the plurality of non-overlapping regions in the predefined cluster determination plot. Each of the plurality of clusters is associated to a unique non-overlapping region of the plurality of non-overlapping regions.

To map the re-scaled cumulative product consumption data with respect to the plurality of non-overlapping regions in the predefined cluster determination plot, at block 212, the cluster generation module 104 identifies a non-overlapping region from the plurality of non-overlapping regions in which a maximum number of data points from amongst at least three data points of the re-scaled cumulative product consumption data lie.

At block 214, the cluster generation module 104 incorporates the re-scaled cumulative product consumption data in a cluster from a plurality of clusters based on the mapping of the re-scaled cumulative product consumption data with respect to the plurality of non-overlapping regions in the predefined cluster determination plot. The re-scaled cumulative product consumption data is incorporated in the cluster that is associated to the identified non-overlapping region.

At block 116, the cluster generation module 104 renders the cluster to determine an optimal unit product value for the product. The optimal unit product value may be a unit selling amount, associated with the product, that maximizes the margin or the demand for the product.

The system 200 comprises a value prediction module 216. In an example, the value prediction module 216 may be implemented via the use of hardware or combinations of hardware and software. In another example, the value prediction module 216 may be coupled to, and accessible by, the processor 102 for execution of the functions of the value prediction module 216. The optimal unit product value may either be determined or predicted by the value prediction module 216 of the system 200 or obtained by the value prediction module 216 of the system 200 through an input received from a user.

In an example, to determine or predict an optimal unit product value for a product, the value prediction module 216 may first determine a relationship between the demand of the product with respect to the varying unit product values based on an analysis of a cluster, from the plurality of clusters, in which the re-scaled cumulative product consumption data of that product is incorporated. Based on the relationship between the demand of the product with respect to the unit product values, the value prediction module 216 may predict the optimal unit product value that maximizes the margin or the demand for the product.

In another example, to determine an optimal unit product value for the product, the plurality of clusters may be presented to a user on a display (not shown) of the system 200 or a display of an external device, such as a mobile device, a computer, a laptop, etc. The system 200 may receive an input, from the user, with respect to an optimal unit product value for a product based on a cluster, from the plurality of clusters, in which the re-scaled cumulative product consumption data of that product is incorporated. For example, if the user observes, through the cluster, that there is a drastic drop in the demand as the unit product value increases, the system may receive an input, from the user, to maintain the unit product value of the product at the current value. In this way, the optimal unit product value for the product may be obtained, by the value prediction module 216, through the input received from the user.

At block 218, the value prediction module 216 provides the optimal unit product value for the product as feedback to the cluster generation module 104. The cluster generation module 104 may update the plurality of clusters based on the optimal unit product value to continuously improve the system 200 for predicting the optimal unit product value.

The cluster generation module 104 may train a machine learning (ML) model for predicting the optimal unit product value, determining the impact of the optimal unit product value on the demand for production of the product, or fine-tuning attributes that impact the production and supply-chain of the product. In an example, inputs to the ML model may be the name, the country, the customer, the product consumption quantity, and the cluster associated with the product. The ML model, in one example, may be a generalized linear model (GLM) or an ensemble method such as eXtreme Gradient Boosting (XGBoost), Light Gradient Boosting Machine (LightGBM), etc. In another example, for the ML model, multiple models could be trained or hyperparameters could be tuned and the most accurate one of the trained models or tuned hyperparameters may be selected using K fold cross validation or based on metrices, such as user preference, root mean square error, area under the curve, associated with the cumulative product consumption data. The ML model may be continuously improved based on the latest set of the inputs and the optimal unit product value. If outputs of the ML model come out to be inaccurate using the latest set of inputs, one of the old ML models may be used by the used so that the ML model continuously improves and a ML model which provides an accurate output is used.

Although the system 100, 200 has been explained to operate with respect to product consumption data for one product, the system 100, 200 may also operate in a similar manner with the product consumption data for a plurality of products, where the re-scaled cumulative product consumption data of each product of the plurality of products may be clustered into a plurality of clusters based on the mapping of the re-scaled cumulative product consumption data with respect to the plurality of non-overlapping regions.

FIG. 3 illustrates a graph of demand curve data 300 for a product, as per one example. In an example, the demand curve data 300 may be prestored in the internal memory of the system 100, 200 or the external memory. The demand curve data 300 may be obtained from the internal memory or the external memory for generating cumulative product consumption data. The demand curve data 300 is indicative of product consumption quantities 302 with respect to the varying unit product values 304 for the product. In other words, the demand curve data 300 is indicative of the relationship between the demand and the unit product value 304 of the product. As per the present subject matter, the demand curve data 300 includes at least three data points (illustrated as solid dots in FIG. 3), the at least three data points being indicative of a product consumption quantity with respect to each unit product value of the varying unit product values for the product.

FIG. 4 illustrates a graph of cumulative product consumption data 400 for a product, as per one example. The cumulative product consumption data 400 is indicative of varying cumulative product consumption quantities 402 with respect to the varying unit product values 404 for the product. The varying unit product values 404 may be same as the varying unit product values 304. As per the present subject matter, the cumulative product consumption data 400 includes at least three data points (illustrated as solid dots in FIG. 4), the at least three data points being indicative of the varying cumulative product consumption quantities 402 with respect to the varying unit product values 404 for the product. In the cumulative product consumption data 400, a cumulative product consumption quantity of the varying cumulative product consumption quantities 402 with respect to a unit product value of the varying unit product values 404 is computed by adding the product consumption quantity 302 at the unit product value and the product consumption quantity 302 at the varying unit product values 304 higher than the unit product value. As a result, in the graph of the cumulative product consumption data 400, the cumulative product consumption quantity 402 decreases with the increase in the unit product value 404.

FIG. 5 illustrates a graph of re-scaled cumulative product consumption data 500 for a product, as per one example. The cumulative product consumption data 400 is re-scaled, by normalizing the varying cumulative product consumption quantities 402 to be within a first predefined numerical range and normalizing the varying unit product values 404 to be within a second predefined numerical range, to form the re-scaled cumulative product consumption data 500. The re-scaled cumulative product consumption data 500 is indicative of scaled cumulative product consumption quantities 502 with respect to scaled unit product values 504 for the product. To normalize the varying cumulative product consumption quantities 402 to be within the first predefined numerical range, each of the varying cumulative product consumption quantities 402 is divided by a maximum value of the varying cumulative product consumption quantities 402. Similarly, to normalize the varying unit product values 404 to be within the second predefined numerical range, each of the varying unit product values 404 is divided by a maximum value of the varying unit product values 404. In an example, the first predefined numerical range may be from 0 to 1 and the second predefined numerical range may be from 0 to 1, as illustrated in FIG. 5.

FIG. 6A illustrates a predefined cluster determination plot 600, as per one example. The predefined cluster determination plot 600 includes a plurality of non-overlapping regions 1 to 5. Each of the plurality of non-overlapping regions 1 to 5 being confined by a subset of values within the first predefined numerical range associated with a cumulative product consumption quantity 602 as ordinates and a subset of values within the second predefined numerical range associated with a unit product value 604 as abscissas. Each of a plurality of clusters is associated to a unique non-overlapping region of the plurality of non-overlapping regions 1 to 5.

The predefined cluster determination plot 600 includes five unique non-overlapping regions 1 to 5. In an example, the plurality of clusters may comprise five clusters. A first cluster of the five clusters may be associated with a first unique non-overlapping region 1 confined by the cumulative product consumption quantity 602 in a range 0 to 0.2 and the unit product value 604 in a range 0 to 0.2. Further, a second cluster of the five clusters may be associated with a second unique non-overlapping region 2 confined by the cumulative product consumption quantity 602 in a range 0.2 to 0.4 and the unit product value 604 in a range 0.2 to 0.4. Further, a third cluster of the five clusters may be associated with a third unique non-overlapping region 3 confined by the cumulative product consumption quantity 602 in a range 0.4 to 0.6 and the unit product value 604 in a range 0.4 to 0.6. Further, a fourth cluster of the five clusters may be associated with a fourth unique non-overlapping region 4 confined by the cumulative product consumption quantity 602 in a range 0.6 to 0.8 and the unit product value 604 in a range 0.6 to 0.8. Further, a fifth cluster of the five clusters may be associated with a fifth unique non-overlapping region 5 confined by the cumulative product consumption quantity 602 in a range 0.8 to 1 and the unit product value 604 in a range 0.8 to 1.

FIG. 6B illustrates a predefined cluster determination plot 610, as per one example. The predefined cluster determination plot 610 includes a plurality of non-overlapping regions 1 to 5. Each of the plurality of non-overlapping regions 1 to 5 being confined by a subset of values within the first predefined numerical range associated with a cumulative product consumption quantity 612 as ordinates and a subset of values within the second predefined numerical range associated with a unit product value 614 as abscissas. Each of a plurality of clusters is associated to a unique non-overlapping region of the plurality of non-overlapping regions 1 to 5.

The predefined cluster determination plot 610 includes five unique non-overlapping regions 1 to 5. In an example, the plurality of clusters may comprise five clusters. A first cluster of the five clusters may be associated with a first unique non-overlapping region 1 confined by the cumulative product consumption quantity 612 in a range 0 to 0.4 and the unit product value 614 in a range 0 to 0.2. Further, a second cluster of the five clusters may be associated with a second unique non-overlapping region 2 confined by the cumulative product consumption quantity 612 in a range 0.2 to 0.6 and the unit product value 614 in a range 0.2 to 0.4. Further, a third cluster of the five clusters may be associated with a third unique non-overlapping region 3 confined by the cumulative product consumption quantity 612 in a range 0.2 to 0.8 and the unit product value 614 in a range 0.4 to 0.6. Further, a fourth cluster of the five clusters may be associated with a fourth unique non-overlapping region 4 confined by the cumulative product consumption quantity 612 in a range 0.4 to 0.8 and the unit product value 614 in a range 0.6 to 0.8. Further, a fifth cluster of the five clusters may be associated with a fifth unique non-overlapping region 5 confined by the cumulative product consumption quantity 612 in a range 0.6 to 1 and the unit product value 614 in a range 0.8 to 1.

In an example, the predefined cluster determination plots 600, 610 may be generated by the processor 102 and stored in the internal memory of the system 100, 200 or in the external memory. In this example, the predefined cluster determination plots 600, 610 may be obtained from the internal memory of the system 200 or the external memory to map the re-scaled cumulative product consumption data 500 with respect to the plurality of non-overlapping regions 1 to 5 in the predefined cluster determination plot 600, 610. To map the re-scaled cumulative product consumption data 500 with respect to the plurality of non-overlapping regions 1 to 5 in the predefined cluster determination plot 600, 610, q non-overlapping region from the plurality of non-overlapping regions 1 to 5 is identified in which a maximum number of data points from amongst at least three data points of the re-scaled cumulative product consumption data 500 lie. The re-scaled cumulative product consumption data 500 is incorporated in a cluster from a plurality of clusters based on the mapping of the re-scaled cumulative product consumption data 500 with respect to the plurality of non-overlapping regions 1 to 5 in the predefined cluster determination plot 600, 610. Thus, the re-scaled cumulative product consumption data 500 may be incorporated in the cluster that is associated to the identified non-overlapping region. For example, upon mapping, if a maximum number of data points from amongst at least three data points of the re-scaled cumulative product consumption data 500 lie in a non-overlapping region 1, then the re-scaled cumulative product consumption data 500 may be incorporated in the first cluster.

FIG. 7 illustrates a plurality of clusters 700, as per one example. The plurality of clusters 700 comprises five clusters, namely, a first cluster 702, a second cluster 704, a third cluster 706, a fourth cluster 708, and a fifth cluster 710. The plurality of clusters 700 have been generated using sample re-scaled cumulative product consumption data for a plurality of products based on mapping with the plurality of non-overlapping regions 1 to 5 in the predefined cluster determination plot 610. Thus, the first cluster 702 is associated with the first unique non-overlapping region 1 in the predefined cluster determination plot 610, the second cluster 704 is associated with the second unique non-overlapping region 2 in the predefined cluster determination plot 610, the third cluster 706 is associated with the third unique non-overlapping region 3 in the predefined cluster determination plot 610, the fourth cluster 708 is associated with the fourth unique non-overlapping region 4 in the predefined cluster determination plot 610, and the fifth cluster 710 is associated with the fifth unique non-overlapping region 5 in the predefined cluster determination plot 610. The plurality of clusters 700 have been illustrated for ease of understanding, as may be well understood, the plurality of clusters described in the present disclosure are not limited merely to those illustrated in FIG. 7.

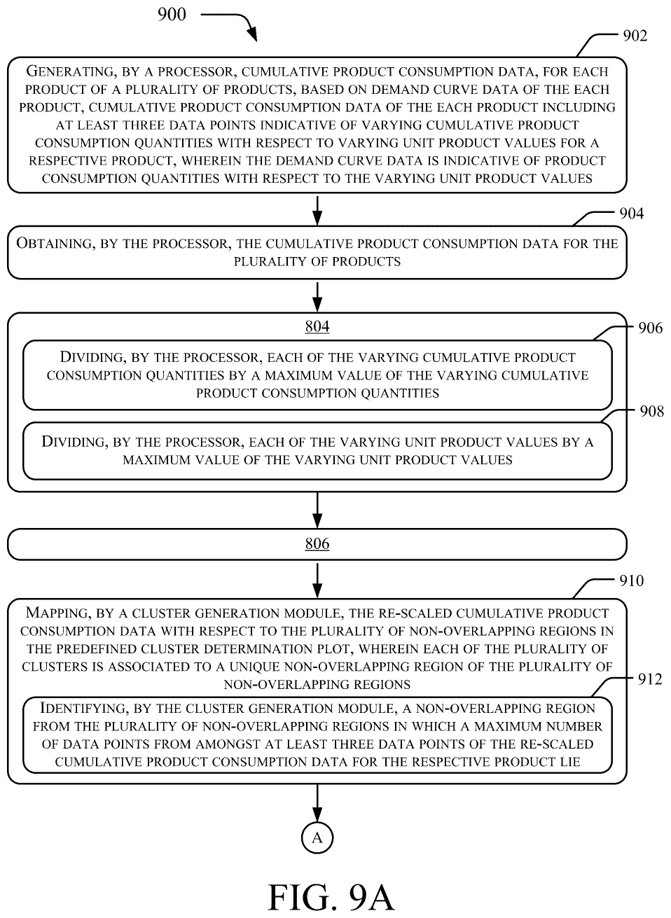

FIG. 8 illustrates a method 800 for product consumption data clustering, according to an example of the present subject matter. The order in which the above-mentioned method 800 is described is not intended to be construed as a limitation, and some of the described method blocks may be combined in a different order to implement the method 800, or an alternative method.

Furthermore, the above-mentioned method 800 may be implemented in a suitable hardware, computer readable instructions, or combination thereof. The steps of such method may be performed by either a system under the instruction of machine executable instructions stored on a non-transitory computer readable medium or by dedicated hardware circuits, microcontrollers, or logic circuits. For example, the method 800 may be performed by a data processing system, such as system 100 or system 200. Herein, some examples are also intended to cover non-transitory computer readable medium, for example, digital data storage media, which are computer readable and encode computer-executable instructions, where said instructions perform some or all the steps of the above-mentioned methods.

In an example, according to the method 800, at block 802, cumulative product consumption data for a plurality of products are obtained by a processor, such as the processor 102 of the system 100, 200. Cumulative product consumption data 400 of each of the plurality of products includes at least three data points indicative of varying cumulative product consumption quantities 402 with respect to varying unit product values 404 for a respective product. The cumulative product consumption data 400, for example, may include data related to the sale of a product, for example, cumulative sales quantities of the product, demand of the product, unit selling amount of the product, discount on the product, etc. A cumulative product consumption quantity of a product may be indicative of a cumulative sales quantity associated with the product. A unit product value of a product may be indicative of a unit selling amount associated with the product.

At block 804, the cumulative product consumption data 400 of each product is re-scaled, by the processor, by normalizing the varying cumulative product consumption quantities 402 to be within a first predefined numerical range and normalizing the varying unit product values 404 to be within a second predefined numerical range.

At block 806, a predefined cluster determination plot 600, 610 generated by the processor is obtained by the processor. The predefined cluster determination plot 600, 610 includes a plurality of non-overlapping regions 1 to 5. Each of the plurality of non-overlapping regions 1 to 5 is confined by a subset of values within the first predefined numerical range associated with a cumulative product consumption quantity 602, 612 and a subset of values within the second predefined numerical range associated with a unit product value 604, 614.

At block 808, the re-scaled cumulative product consumption data 500 is mapped, by a cluster generation module 104, with respect to the plurality of non-overlapping regions 1 to 5 in the predefined cluster determination plot 600, 610.

At block 810, the re-scaled cumulative product consumption data 500 of the each product is clustered, by the cluster generation module 104, into a plurality of clusters 700 based on the mapping of the re-scaled cumulative product consumption data 500 with respect to the plurality of non-overlapping regions 1 to 5.

At block 812, the plurality of clusters 700 is rendered, by the cluster generation module 104, for determining an optimal unit product value for at least one of the plurality of products. The optimal unit product value may be a unit selling amount, associated with the product, that maximizes the margin or the demand for the product.

At block 814, at least the optimal unit product value for at least one of the plurality of products is provided, by a value prediction module 216, as feedback to the cluster generation module 104. The optimal unit product value may either be determined or predicted by the value prediction module 216 of the system 200 or obtained by the value prediction module 216 of the system 200 through an input received from a user. The cluster generation module 104 may update the plurality of clusters 700 based on the optimal unit product value to continuously improve the system 100, 200 for predicting the optimal unit product value.

In an example, to determine or predict an optimal unit product value for a product, a relationship between the demand of the product with respect to the varying unit product values 404 is determined, by the value prediction module 216, based on an analysis of a cluster, from the plurality of clusters 700, in which the re-scaled cumulative product consumption data 500 of that product is incorporated. Based on the relationship between the demand of the product with respect to the unit product values 404, the optimal unit product value, that maximizes the margin or the demand for the product, is predicted by the value prediction module 216.

In another example, to determine an optimal unit product value for the product, the plurality of clusters 700 may be presented to a user on a display (not shown) of the system 200 or a display of an external device, such as a mobile device, a computer, a laptop, etc. An input may be received from the user with respect to an optimal unit product value for a product based on a cluster, from the plurality of clusters 700, in which the re-scaled cumulative product consumption data 500 of that product is incorporated. For example, if the user observes, through the cluster, that there is a drastic drop in the demand as the unit product value 404 increases, an input may be received from the user to maintain the unit product value of the product at the current value. In this way, the optimal unit product value for the product may be obtained, by the value prediction module 216, through the input received from the user.

The cluster generation module 104 may train a machine learning (ML) model for predicting the optimal unit product value, determining the impact of the optimal unit product value on the demand for production of the product, or fine-tuning attributes that impact the production and supply-chain of the product. In an example, inputs to the ML model may be the name, the country, the customer, the product consumption quantity, and the cluster associated with the product. The ML model, in one example, may be a generalized linear model (GLM) or an ensemble method such as eXtreme Gradient Boosting (XGBoost), Light Gradient Boosting Machine (LightGBM), etc. In another example, for the ML model, multiple models could be trained or hyperparameters could be tuned and the most accurate one of the trained models or tuned hyperparameters may be selected using K fold cross validation or based on metrices, for example, metrices as per user preference, root mean square error, area under the curve, etc., associated with the cumulative product consumption data. The ML model may be continuously improved based on the latest set of the inputs and the optimal unit product value. If outputs of the ML model come out to be inaccurate using the latest set of inputs, one of the old ML models may be used by the used so that the ML model continuously improves and a ML model which provides an accurate output is used.

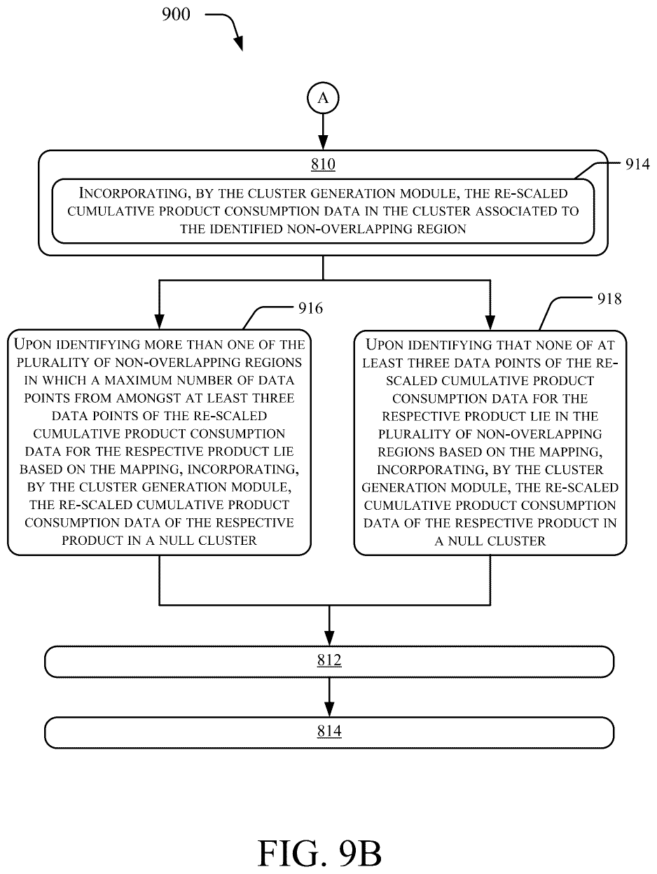

FIG. 9A and FIG. 9B illustrate a method 900 for product consumption data clustering, according to an example of the present subject matter. The order in which the above-mentioned method 900 is described is not intended to be construed as a limitation, and some of the described method blocks may be combined in a different order to implement the method 900, or an alternative method.

Furthermore, the above-mentioned method 900 may be implemented in a suitable hardware, computer readable instructions, or combination thereof. The steps of such method may be performed by either a system under the instruction of machine executable instructions stored on a non-transitory computer readable medium or by dedicated hardware circuits, microcontrollers, or logic circuits. For example, the method 900 may be performed by a data processing system, such as system 100 or system 200. Herein, some examples are also intended to cover non-transitory computer readable medium, for example, digital data storage media, which are computer readable and encode computer-executable instructions, where said instructions perform some or all the steps of the above-mentioned methods.

In an example, according to the method 900, at block 902, cumulative product consumption data 400, for each product of a plurality of products, is generated, by a processor 102 based on demand curve data 300 of the each product. Cumulative product consumption data 400 of the each product includes at least three data points indicative of varying cumulative product consumption quantities 402 with respect to varying unit product values 404 for a respective product. The demand curve data 300 is indicative of product consumption quantities 302 with respect to the varying unit product values 304. A product consumption quantity of a product may be indicative of a sales quantity associated with the product. A unit product value of a product may be indicative of a unit selling amount associated with the product.

At block 904, the cumulative product consumption data 400 for the plurality of products is obtained by the processor 102. In an example, the cumulative product consumption data 400 may be obtained from the internal memory of the system 100, 200 or the external memory.

At block 804, the cumulative product consumption data 400 of the each product is re-scaled, by the processor 102, by normalizing the varying cumulative product consumption quantities 402 to be within a first predefined numerical range and normalizing the varying unit product values 404 to be within a second predefined numerical range. To normalize the varying cumulative product consumption quantities 402 to be within the first predefined numerical range, at block 906, each of the varying cumulative product consumption quantities 402 is divided, by the processor 102, by a maximum value of the varying cumulative product consumption quantities 402. Similarly, to normalize the varying unit product values 404 to be within the second predefined numerical range, at block 908, each of the varying unit product values 404 is divided, by the processor 102, by a maximum value of the varying unit product values 404.

At block 806, a predefined cluster determination plot 600, 610 generated by the processor 102 is obtained by the processor 102. In an example, the predefined cluster determination plot 600, 610 generated by the processor 102 may be stored in the internal memory of the system 100, 200 or in the external memory. In this example, the predefined cluster determination plot 600, 610 may be obtained from the internal memory of the system 100, 200 or the external memory. The predefined cluster determination plot 600, 610 includes a plurality of non-overlapping regions 1 to 5. Each of the plurality of non-overlapping regions 1 to 5 is confined by a subset of values within the first predefined numerical range associated with a cumulative product consumption quantity 602, 612 and a subset of values within the second predefined numerical range associated with a unit product value 604, 614.

At block 910, the re-scaled cumulative product consumption data 500 is mapped, by a cluster generation module 104, with respect to the plurality of non-overlapping regions 1 to 5 in the predefined cluster determination plot 600, 610. Each of the plurality of clusters 700 is associated to a unique non-overlapping region of the plurality of non-overlapping regions 1 to 5. The mapping of the re-scaled cumulative product consumption data 500 with respect to the plurality of non-overlapping regions 1 to 5 in the predefined cluster determination plot 600, 610 comprises, at block 912, identifying, by the cluster generation module 104, a non-overlapping region from the plurality of non-overlapping regions 1 to 5 in which a maximum number of data points from amongst at least three data points of the re-scaled cumulative product consumption data 500 for the respective product lie.

At block 810, the re-scaled cumulative product consumption data 500 of the each product is clustered, by a cluster generation module 104, into a plurality of clusters 700 based on the mapping of the re-scaled cumulative product consumption data 500 with respect to the plurality of non-overlapping regions 1 to 5. The clustering comprises, at block 914, incorporating, by the cluster generation module 104, the re-scaled cumulative product consumption data 500 in the cluster associated to the identified non-overlapping region.

At block 916, upon identifying more than one of the plurality of non-overlapping regions 1 to 5 in which a maximum number of data points from amongst at least three data points of the re-scaled cumulative product consumption data 500 for the respective product lie based on the mapping, the re-scaled cumulative product consumption data 500 of the respective product is incorporated, by the cluster generation module 104, in a null cluster.

At block 918, upon identifying that none of at least three data points of the re-scaled cumulative product consumption data 500 for the respective product lie in the plurality of non-overlapping regions 1 to 5 based on the mapping, the re-scaled cumulative product consumption data 500 of the respective product is incorporated, by the cluster generation module 104, in a null cluster.

At block 812, the plurality of clusters 700 is rendered, by the cluster generation module 104, for determining an optimal unit product value for at least one of the plurality of products. The optimal unit product value may be a unit selling amount, associated with the product, that maximizes the margin or the demand for the product.

At block 814, at least the optimal unit product value for at least one of the plurality of products is provided, by a value prediction module 216, as feedback to the cluster generation module 104. The optimal unit product value may either be determined or predicted by the value prediction module 216 of the system 200 or obtained by the value prediction module 216 of the system 200 through an input received from a user. The cluster generation module 104 may update the plurality of clusters 700 based on the optimal unit product value to continuously improve the system 100, 200 for predicting the optimal unit product value.

In an example, to determine or predict an optimal unit product value for a product, a relationship between the demand of the product with respect to the varying unit product values 404 is determined, by the value prediction module 216, based on an analysis of a cluster, from the plurality of clusters 700, in which the re-scaled cumulative product consumption data 500 of that product is incorporated. Based on the relationship between the demand of the product with respect to the unit product values 404, the optimal unit product value, that maximizes the margin or the demand for the product, is predicted by the value prediction module 216.

In another example, to determine an optimal unit product value for the product, the plurality of clusters 700 may be presented to a user on a display (not shown) of the system 200 or a display of an external device, such as a mobile device, a computer, a laptop, etc. An input may be received from the user with respect to an optimal unit product value for a product based on a cluster, from the plurality of clusters 700, in which the re-scaled cumulative product consumption data 500 of that product is incorporated. For example, if the user observes, through the cluster, that there is a drastic drop in the demand as the unit product value 404 increases, an input may be received from the user to maintain the unit product value of the product at the current value. In this way, the optimal unit product value for the product may be obtained, by the value prediction module 216, through the input received from the user.

The cluster generation module 104 may train a machine learning (ML) model for predicting the optimal unit product value, determining the impact of the optimal unit product value on the demand for production of the product, or fine-tuning attributes that impact the production and supply-chain of the product. In an example, inputs to the ML model may be the name, the country, the customer, the product consumption quantity, and the cluster associated with the product. The ML model, in one example, may be a generalized linear model (GLM) or an ensemble method such as eXtreme Gradient Boosting (XGBoost), Light Gradient Boosting Machine (LightGBM), etc. In another example, for the ML model, multiple models could be trained or hyperparameters could be tuned and the most accurate one of the trained models or tuned hyperparameters may be selected using K fold cross validation or based on metrices, for example, metrices as per user preference, root mean square error, area under the curve, etc., associated with the cumulative product consumption data. The ML model may be continuously improved based on the latest set of the inputs and the optimal unit product value. If outputs of the ML model come out to be inaccurate using the latest set of inputs, one of the old ML models may be used by the used so that the ML model continuously improves and a ML model which provides an accurate output is used.

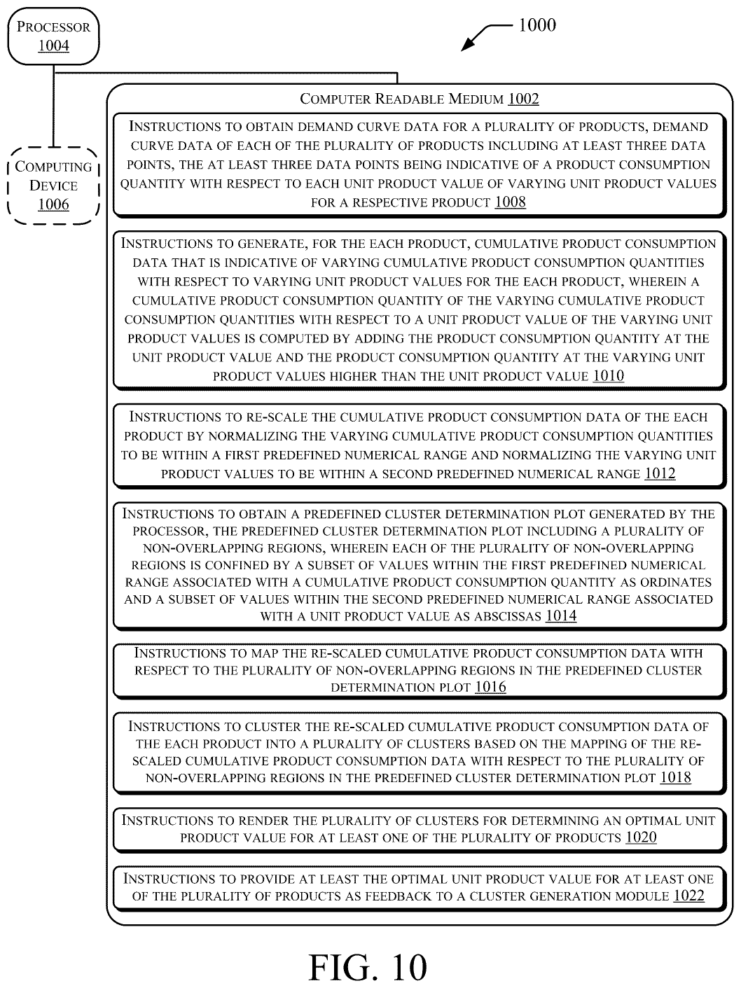

FIG. 10 illustrates a system environment 1000 implementing a non-transitory computer readable medium 1002 for product consumption data clustering, according to an example of the present subject matter. The system environment 1000 includes a processor 1004 communicatively coupled to the non-transitory computer readable medium 1002. In an example, the processor 1004 may have one or more processing resources for fetching and executing computer readable instructions from the non-transitory computer readable medium 1002 for communication with a computing device 1006. The processor 1004 and the non-transitory computer readable medium 1002 may be implemented, for example, in the processor 102 of the system 100, 200 (as has been described in conjunction with the preceding figures).

The non-transitory computer readable medium 1002 can be, for example, an internal memory device or an external memory device. In an example implementation, the processor 1004 may be communicatively coupled to the non-transitory computer readable medium 1002 through a communication link. The communication link may be a direct communication link, such as any memory read/write interface. In another example implementation, the communication link may be an indirect communication link, such as a network interface. In such a case, the processor 1004 can access the non-transitory computer readable medium 1002 through a communication network.

In an example implementation, the non-transitory computer readable medium 1002 includes a set of computer readable instructions for product consumption data clustering. The set of computer readable instructions can be accessed by the processor 1004 and subsequently executed to perform acts for product consumption data clustering. The processor 1004 may communicate with the computing device 1006.

Referring to FIG. 10, in an example, the non-transitory computer readable medium 1002 includes instructions 1008 to perform operation comprising obtaining demand curve data for a plurality of products. Demand curve data 300 of each of the plurality of products includes at least three data points. The at least three data points are indicative of a product consumption quantity 302 with respect to each unit product value of varying unit product values 304 for a respective product. A product consumption quantity of a product may be indicative of a sales quantity associated with the product. A unit product value of a product may be indicative of a unit selling amount associated with the product.

The non-transitory computer readable medium 1002 includes instructions 1010 to perform operation comprising generating, for the each product, cumulative product consumption data 400 that is indicative of varying cumulative product consumption quantities 402 with respect to varying unit product values 404 for the each product. A cumulative product consumption quantity of the varying cumulative product consumption quantities 402 with respect to a unit product value of the varying unit product values 404 is computed by adding the product consumption quantity at the unit product value and the product consumption quantity at the varying unit product values 304 higher than the unit product value.

The non-transitory computer readable medium 1002 includes instructions 1012 to perform operation comprising re-scaling the cumulative product consumption data 400 of the each product by normalizing the varying cumulative product consumption quantities 402 to be within a first predefined numerical range and normalizing the varying unit product values 404 to be within a second predefined numerical range.

The non-transitory computer readable medium 1002 includes instructions 1014 to perform operation comprising obtaining a predefined cluster determination plot 600, 610 generated by the processor 102. The predefined cluster determination plot 600, 610 includes a plurality of non-overlapping regions 1 to 5. Each of the plurality of non-overlapping regions 1 to 5 is confined by a subset of values within the first predefined numerical range associated with a cumulative product consumption quantity 602, 612 as ordinates and a subset of values within the second predefined numerical range associated with a unit product value 604, 614 as abscissas. The predefined cluster determination plot 600, 610 may be same as explained with respect to FIG. 6A and FIG. 6B.

The non-transitory computer readable medium 1002 includes instructions 1016 to perform operation comprising mapping the re-scaled cumulative product consumption data 500 with respect to the plurality of non-overlapping regions 1 to 5 in the predefined cluster determination plot 600, 610.

The non-transitory computer readable medium 1002 includes instructions 1018 to perform operation comprising clustering the re-scaled cumulative product consumption data 500 of the each product into a plurality of clusters 700 based on the mapping of the re-scaled cumulative product consumption data 500 with respect to the plurality of non-overlapping regions 1 to 5 in the predefined cluster determination plot 600, 610. Each of the plurality of clusters 700 may be associated to a unique non-overlapping region of the plurality of non-overlapping regions 1 to 5. For mapping of the re-scaled cumulative product consumption data 500 with respect to the plurality of non-overlapping regions 1 to 5 in the predefined cluster determination plot 600, 610, the instructions (not shown) may further perform operation comprising identifying a non-overlapping region from the plurality of non-overlapping regions 1 to 5 in which a maximum number of data points from amongst at least three data points of the re-scaled cumulative product consumption data 500 for the respective product lie. Further, for clustering, the instructions (not shown) may perform operation comprising incorporating the re-scaled cumulative product consumption data 500 in the cluster associated to the identified non-overlapping region.

For normalizing the varying cumulative product consumption quantities 402 to be within the first predefined numerical range, the instructions (not shown) may perform operation comprising dividing each of the varying cumulative product consumption quantities 402 by a maximum value of the varying cumulative product consumption quantities 402. Further, for normalizing the varying unit product values 404 to be within the second predefined numerical range, the instructions (not shown) may further comprise dividing each of the varying unit product values 404 by a maximum value of the varying unit product values 404. In an example, the first predefined numerical range may be from 0 to 1 and the second predefined numerical range may be from 0 to 1.

The non-transitory computer readable medium 1002 includes instructions 1020 to perform operation comprising rendering the plurality of clusters 700 for determining an optimal unit product value for at least one of the plurality of products. The optimal unit product value may be a unit selling amount, associated with the product, that maximizes the margin or the demand for the product.

The non-transitory computer readable medium 1002 includes instructions 1022 to perform operation comprising providing at least the optimal unit product value for at least one of the plurality of products as feedback to a cluster generation module 104. The optimal unit product value may either be determined or predicted by the value prediction module 216 of the system 200 or obtained by the value prediction module 216 of the system 200 through an input received from a user. The cluster generation module 104 may update the plurality of clusters 700 based on the optimal unit product value to continuously improve the system 100, 200 for predicting the optimal unit product value.

In an example, to determine or predict an optimal unit product value for a product, a relationship between the demand of the product with respect to the varying unit product values 404 is determined, by the value prediction module 216, based on an analysis of a cluster, from the plurality of clusters 700, in which the re-scaled cumulative product consumption data 500 of that product is incorporated. Based on the relationship between the demand of the product with respect to the unit product values 404, the optimal unit product value, that maximizes the margin or the demand for the product, is predicted by the value prediction module 216.

In another example, to determine an optimal unit product value for the product, the plurality of clusters 700 may be presented to a user on a display (not shown) of the system 200 or a display of an external device, such as a mobile device, a computer, a laptop, etc. An input may be received from the user with respect to an optimal unit product value for a product based on a cluster, from the plurality of clusters 700, in which the re-scaled cumulative product consumption data 500 of that product is incorporated. For example, if the user observes, through the cluster, that there is a drastic drop in the demand as the unit product value 404 increases, an input may be received from the user to maintain the unit product value of the product at the current value. In this way, the optimal unit product value for the product may be obtained, by the value prediction module 216, through the input received from the user.

A machine learning (ML) model may be trained for predicting the optimal unit product value, determining the impact of the optimal unit product value on the demand for production of the product, or fine-tuning attributes that impact the production and supply-chain of the product. In an example, inputs to the ML model may be the name, the country, the customer, the product consumption quantity, and the cluster associated with the product. The ML model, in one example, may be a generalized linear model (GLM) or an ensemble method such as eXtreme Gradient Boosting (XGBoost), Light Gradient Boosting Machine (LightGBM), etc. In another example, for the ML model, multiple models could be trained or hyperparameters could be tuned and the most accurate one of the trained models or tuned hyperparameters may be selected using K fold cross validation or based on metrices, for example, metrices as per user preference, root mean square error, area under the curve, etc., associated with the cumulative product consumption data. The ML model may be continuously improved based on the latest set of the inputs and the optimal unit product value. If outputs of the ML model come out to be inaccurate using the latest set of inputs, one of the old ML models may be used by the used so that the ML model continuously improves and a ML model which provides an accurate output is used.

Although examples for the present disclosure have been described in language specific to structural features and/or methods, it is to be understood that the appended claims are not necessarily limited to the specific features or methods described. Rather, the specific features and methods are disclosed and explained as examples of the present disclosure.

We claim:

1. A method comprising:
obtaining, by a processor, cumulative product consumption data for a plurality of products, cumulative product consumption data of each of the plurality of products including at least three data points indicative of varying cumulative product consumption quantities with respect to varying unit product values for a respective product;
re-scaling, by the processor, the cumulative product consumption data of each product by normalizing the varying cumulative product consumption quantities to be within a first predefined numerical range and normalizing the varying unit product values to be within a second predefined numerical range;
obtaining, by the processor, a predefined cluster determination plot generated by the processor, the predefined cluster determination plot including a plurality of non-overlapping regions, each of the plurality of non-overlapping regions being confined by a subset of values within the first predefined numerical range associated with a cumulative product consumption quantity and a subset of values within the second predefined numerical range associated with a unit product value;
mapping, by a cluster generation module, the re-scaled cumulative product consumption data with respect to the plurality of non-overlapping regions in the predefined cluster determination plot; and
clustering, by the cluster generation module, the re-scaled cumulative product consumption data of each product into a plurality of clusters based on the mapping of the re-scaled cumulative product consumption data with respect to the plurality of non-overlapping regions;
rendering, by the cluster generation module, the plurality of clusters for determining an optimal unit product value for at least one of the plurality of products; and
providing, by a value prediction module, at least the optimal unit product value for at least one of the plurality of products as feedback to the cluster generation module.

2. The method of claim 1,
wherein each of the plurality of clusters is associated to a unique non-overlapping region of the plurality of non-overlapping regions;
wherein the mapping of the re-scaled cumulative product consumption data with respect to the plurality of non-overlapping regions in the predefined cluster determination plot comprises:
identifying, by the cluster generation module, a non-overlapping region from the plurality of non-overlapping regions in which a maximum number of data points from amongst at least three data points of the re-scaled cumulative product consumption data for the respective product lie; and
wherein the clustering comprises:
incorporating, by the cluster generation module, the re-scaled cumulative product consumption data in the cluster associated to the identified non-overlapping region.

3. The method of claim 1, wherein the method comprises:
generating, by the processor, the cumulative product consumption data of the each product based on demand curve data of the each product, wherein the demand curve data is indicative of product consumption quantities with respect to the varying unit product values.

4. The method of claim 1,
wherein normalizing the varying cumulative product consumption quantities in the first predefined numerical range comprises:
dividing, by the processor, each of the varying cumulative product consumption quantities by a maximum value of the varying cumulative product consumption quantities; and
wherein normalizing the varying unit product values in the second predefined numerical range comprises:
dividing, by the processor, each of the varying unit product values by a maximum value of the varying unit product values.

5. The method of claim 1,
wherein the first predefined numerical range is from 0 to 1,
wherein the second predefined numerical range is from 0 to 1,
wherein the plurality of clusters comprises five clusters,
wherein a first cluster of the five clusters is associated with a first unique non-overlapping region confined by the cumulative product consumption quantity in a range 0 to 0.4 and the unit product value in a range 0 to 0.2,
wherein a second cluster of the five clusters is associated with a second unique non-overlapping region confined by the cumulative product consumption quantity in a range 0.2 to 0.6 and the unit product value in a range 0.2 to 0.4,
wherein a third cluster of the five clusters is associated with a third unique non-overlapping region confined by the cumulative product consumption quantity in a range 0.2 to 0.8 and the unit product value in a range 0.4 to 0.6,
wherein a fourth cluster of the five clusters is associated with a fourth unique non-overlapping region confined by the cumulative product consumption quantity in a range 0.4 to 0.8 and the unit product value in a range 0.6 to 0.8, and
wherein a fifth cluster of the five clusters is associated with a fifth unique non-overlapping region confined by the cumulative product consumption quantity in a range 0.6 to 1 and the unit product value in a range 0.8 to 1.

6. The method of claim 1,
wherein the first predefined numerical range is from 0 to 1,
wherein the second predefined numerical range is from 0 to 1,
wherein the plurality of clusters comprises five clusters,
wherein a first cluster of the five clusters is associated with a first unique non-overlapping region confined by the cumulative product consumption quantity in a range 0 to 0.2 and the unit product value in a range 0 to 0.2,
wherein a second cluster of the five clusters is associated with a second unique non-overlapping region confined by the cumulative product consumption quantity in a range 0.2 to 0.4 and the unit product value in a range 0.2 to 0.4,
wherein a third cluster of the five clusters is associated with a third unique non-overlapping region confined by the cumulative product consumption quantity in a range 0.4 to 0.6 and the unit product value in a range 0.4 to 0.6,
wherein a fourth cluster of the five clusters is associated with a fourth unique non-overlapping region confined by the cumulative product consumption quantity in a range 0.6 to 0.8 and the unit product value in a range 0.6 to 0.8, and
wherein a fifth cluster of the five clusters is associated with a fifth unique non-overlapping region confined by the cumulative product consumption quantity in a range 0.8 to 1 and the unit product value in a range 0.8 to 1.

7. The method of claim 1, wherein the method comprises:
upon identifying more than one of the plurality of non-overlapping regions in which a maximum number of data points from amongst at least three data points of the re-scaled cumulative product consumption data for the respective product lie based on the mapping, incorporating, by the cluster generation module, the re-scaled cumulative product consumption data of the respective product in a null cluster.

8. The method of claim 1, wherein the method comprises:
upon identifying that none of at least three data points of the re-scaled cumulative product consumption data for the respective product lie in the plurality of non-overlapping regions based on the mapping, incorporating, by the cluster generation module, the re-scaled cumulative product consumption data of the respective product in a null cluster.

9. A system comprising:
a processor to:
obtain cumulative product consumption data for a product, the cumulative product consumption data including at least three data points, the at least three data points being indicative of varying cumulative product consumption quantities with respect to varying unit product values for the product;
re-scale the cumulative product consumption data by normalizing the varying cumulative product consumption quantities to be within a first predefined numerical range and normalizing the varying unit product values to be within a second predefined numerical range; and
obtain a predefined cluster determination plot generated by the processor, the predefined cluster determination plot including a plurality of non-overlapping regions, each of the plurality of non-overlapping regions being confined by a subset of values within the first predefined numerical range associated with a cumulative product consumption quantity as ordinates and a subset of values within the second predefined numerical range associated with a unit product value as abscissas; and
a cluster generation module to:
map the re-scaled cumulative product consumption data with respect to the plurality of non-overlapping regions in the predefined cluster determination plot;
incorporate the re-scaled cumulative product consumption data in a cluster from a plurality of clusters based on the mapping of the re-scaled cumulative product consumption data with respect to the plurality of non-overlapping regions in the predefined cluster determination plot; and
render the cluster to determine an optimal unit product value for the product.

10. The system of claim 9,
wherein each of the plurality of clusters is associated to a unique non-overlapping region of the plurality of non-overlapping regions;
wherein to map the re-scaled cumulative product consumption data with respect to the plurality of non-overlapping regions in the predefined cluster determination plot, the cluster generation module is to:
identify a non-overlapping region from the plurality of non-overlapping regions in which a maximum number of data points from amongst at least three data points of the re-scaled cumulative product consumption data lie; and
wherein the re-scaled cumulative product consumption data is incorporated in the cluster that is associated to the identified non-overlapping region.

11. The system of claim 9, wherein the system comprises:
a value prediction module to provide the optimal unit product value for the product as feedback to the cluster generation module.

12. The system of claim 9, wherein the processor is to:
obtain demand curve data indicative of a product consumption quantity of the product with respect to each of the varying unit product values; and
compute a cumulative product consumption quantity of the varying cumulative product consumption quantities with respect to a unit product value of the varying unit product values by adding the product consumption quantity at the unit product value and the product consumption quantity at the varying unit product values higher than the unit product value.

13. The system of claim 9,
wherein to normalize the varying cumulative product consumption quantities in the first predefined numerical range, the processor is to:
divide each of the varying cumulative product consumption quantities by a maximum value of the varying cumulative product consumption quantities; and
wherein to normalize the varying unit product values in the second predefined numerical range, the processor is to:
divide each of the varying unit product values by a maximum value of the varying unit product values.

14. The system of claim 13, wherein the plurality of clusters comprises five clusters,
wherein a first cluster of the five clusters is associated with a first unique non-overlapping region confined by the cumulative product consumption quantity in a range 0 to 0.4 and the unit product value in a range 0 to 0.2,
wherein a second cluster of the five clusters is associated with a second unique non-overlapping region confined by the cumulative product consumption quantity in a range 0.2 to 0.6 and the unit product value in a range 0.2 to 0.4,
wherein a third cluster of the five clusters is associated with a third unique non-overlapping region confined by the cumulative product consumption quantity in a range 0.2 to 0.8 and the unit product value in a range 0.4 to 0.6,
wherein a fourth cluster of the five clusters is associated with a fourth unique non-overlapping region confined by the cumulative product consumption quantity in a range 0.4 to 0.8 and the unit product value in a range 0.6 to 0.8, and
wherein a fifth cluster of the five clusters is associated with a fifth unique non-overlapping region confined by the cumulative product consumption quantity in a range 0.6 to 1 and the unit product value in a range 0.8 to 1.

15. The system of claim 13, wherein the plurality of clusters comprises five clusters,
wherein a first cluster of the five clusters is associated with a first unique non-overlapping region confined by the cumulative product consumption quantity in a range 0 to 0.2 and the unit product value in a range 0 to 0.2,
wherein a second cluster of the five clusters is associated with a second unique non-overlapping region confined by the cumulative product consumption quantity in a range 0.2 to 0.4 and the unit product value in a range 0.2 to 0.4,
wherein a third cluster of the five clusters is associated with a third unique non-overlapping region confined by the cumulative product consumption quantity in a range 0.4 to 0.6 and the unit product value in a range 0.4 to 0.6,
wherein a fourth cluster of the five clusters is associated with a fourth unique non-overlapping region confined by the cumulative product consumption quantity in a range 0.6 to 0.8 and the unit product value in a range 0.6 to 0.8, and
wherein a fifth cluster of the five clusters is associated with a fifth unique non-overlapping region confined by the cumulative product consumption quantity in a range 0.8 to 1 and the unit product value in a range 0.8 to 1.

16. A non-transitory computer readable medium having instructions stored thereon, the instructions, when executed by a processor, cause the processor to perform operations comprising:
obtaining demand curve data for a plurality of products, demand curve data of each of the plurality of products including at least three data points, the at least three data points being indicative of a product consumption quantity with respect to each unit product value of varying unit product values for a respective product;
generating, for the each product, cumulative product consumption data that is indicative of varying cumulative product consumption quantities with respect to varying unit product values for the each product, wherein a cumulative product consumption quantity of the varying cumulative product consumption quantities with respect to a unit product value of the varying unit product values is computed by adding the product consumption quantity at the unit product value and the product consumption quantity at the varying unit product values higher than the unit product value;
re-scaling the cumulative product consumption data of the each product by normalizing the varying cumulative product consumption quantities to be within a first predefined numerical range and normalizing the varying unit product values to be within a second predefined numerical range;
obtaining a predefined cluster determination plot generated by the processor, the predefined cluster determination plot including a plurality of non-overlapping regions, wherein each of the plurality of non-overlapping regions is confined by a subset of values within the first predefined numerical range associated with a cumulative product consumption quantity as ordinates and a subset of values within the second predefined numerical range associated with a unit product value as abscissas;
mapping the re-scaled cumulative product consumption data with respect to the plurality of non-overlapping regions in the predefined cluster determination plot;
clustering the re-scaled cumulative product consumption data of the each product into a plurality of clusters based on the mapping of the re-scaled cumulative product consumption data with respect to the plurality of non-overlapping regions in the predefined cluster determination plot;
rendering the plurality of clusters for determining an optimal unit product value for at least one of the plurality of products; and
providing at least the optimal unit product value for at least one of the plurality of products as feedback to a cluster generation module.

17. The non-transitory computer readable medium of claim 16,
wherein each of the plurality of clusters is associated to a unique non-overlapping region of the plurality of non-overlapping regions;
wherein the mapping of the re-scaled cumulative product consumption data with respect to the plurality of non-overlapping regions in the predefined cluster determination plot comprises:
identifying a non-overlapping region from the plurality of non-overlapping regions in which a maximum number of data points from amongst at least three data points of the re-scaled cumulative product consumption data for the respective product lie; and
wherein the clustering comprises:
incorporating the re-scaled cumulative product consumption data in the cluster associated to the identified non-overlapping region.

18. The non-transitory computer readable medium of claim 18,
wherein normalizing the varying cumulative product consumption quantities in the first predefined numerical range comprises:
dividing each of the varying cumulative product consumption quantities by a maximum value of the varying cumulative product consumption quantities; and
wherein normalizing the varying unit product values in the second predefined numerical range comprises:
dividing each of the varying unit product values by a maximum value of the varying unit product values.

19. The non-transitory computer readable medium of claim 16,
wherein the first predefined numerical range is from 0 to 1,
wherein the second predefined numerical range is from 0 to 1,
wherein the plurality of clusters comprises five clusters,
wherein a first cluster of the five clusters is associated with a first unique non-overlapping region confined by the cumulative product consumption quantity in a range 0 to 0.4 and the unit product value in a range 0 to 0.2,
wherein a second cluster of the five clusters is associated with a second unique non-overlapping region confined by the cumulative product consumption quantity in a range 0.2 to 0.6 and the unit product value in a range 0.2 to 0.4,
wherein a third cluster of the five clusters is associated with a third unique non-overlapping region confined by the cumulative product consumption quantity in a range 0.2 to 0.8 and the unit product value in a range 0.4 to 0.6,
wherein a fourth cluster of the five clusters is associated with a fourth unique non-overlapping region confined by the cumulative product consumption quantity in a range 0.4 to 0.8 and the unit product value in a range 0.6 to 0.8, and
wherein a fifth cluster of the five clusters is associated with a fifth unique non-overlapping region confined by the cumulative product consumption quantity in a range 0.6 to 1 and the unit product value in a range 0.8 to 1.

20. The non-transitory computer readable medium of claim 16,
wherein the first predefined numerical range is from 0 to 1,
wherein the second predefined numerical range is from 0 to 1, wherein the plurality of clusters comprises five clusters,
wherein a first cluster of the five clusters is associated with a first unique non-overlapping region confined by the cumulative product consumption quantity in a range 0 to 0.2 and the unit product value in a range 0 to 0.2,
wherein a second cluster of the five clusters is associated with a second unique non-overlapping region confined by the cumulative product consumption quantity in a range 0.2 to 0.4 and the unit product value in a range 0.2 to 0.4,
wherein a third cluster of the five clusters is associated with a third unique non-overlapping region confined by the cumulative product consumption quantity in a range 0.4 to 0.6 and the unit product value in a range 0.4 to 0.6,
wherein a fourth cluster of the five clusters is associated with a fourth unique non-overlapping region confined by the cumulative product consumption quantity in a range 0.6 to 0.8 and the unit product value in a range 0.6 to 0.8, and
wherein a fifth cluster of the five clusters is associated with a fifth unique non-overlapping region confined by the cumulative product consumption quantity in a range 0.8 to 1 and the unit product value in a range 0.8 to 1.
